(19) United States
(12) Patent Application Publication
(10) Pub. No.: US 2015/0084297 A1
(43) Pub. Date: Mar. 26, 2015

(54) Dolly for Moving, Stacking, and Storing Tubular Truss

(71) Applicant: Entertainment Structural Products, Essington, PA (US)

(72) Inventor: Michael P.A. Chouinard, Swarthmore, PA (US)

(21) Appl. No.: 14/495,870

(22) Filed: Sep. 24, 2014

Related U.S. Application Data
(60) Provisional application No. 61/881,899, filed on Sep. 24, 2013.

(51) Int. Cl. B62B 3/10; B62B 3/04

(52) U.S. Cl. CPC B62B 3/10; B62B 3/04
USPC 280/47.34

(57) ABSTRACT

A dolly is provided for us in moving, stacking and storing tubular truss.

### BACKGROUND OF THE INVENTION

The present invention relates to the field of moving, stacking, and storing tubular truss. Temporary stage structures made out of tubular space frame truss are used in the entertainment industry for concerts and to outfit halls. There is a need in the entertainment industry for a dolly which can be used to move tubular truss in and out of trucks. It would be greatly beneficial to have a dolly that could hold truss securely while also sitting on top of a truss, allowing tubular truss to be stacked either for transportation or for storage.

### BRIEF DESCRIPTION OF THE DRAWINGS

The features of the present invention are set forth with particularity in the appended claims. The present invention, both as to its organization and manner of operation, together with further objects and advantages thereof, may be best understood with reference to the following description, taken n connection with the accompanying drawings in which

FIG. 1 is a perspective view of an embodiment of a dolly;

FIG. 2A is a side view of an embodiment of a dolly;

FIG. 2B is an end view of an embodiment of a dolly;

FIG. 3 is a side view of an embodiment of a doily sectioned in half lengthwise with tubular truss attached;

FIG. 4A is a perspective view of a first dolly with a stack of truss attached and a second dolly with a stack of truss attached;

FIG. 4B is a perspective view of a first dolly with a stack of truss attached and a second dolly with a stack of truss attached wherein the first truss-dolly stack is strapped to the second truss-dolly stack; and

FIG. 5 is a perspective view of an embodiment of a dolly comprising a retractable tensionable strap in accordance with the invention.

### SPECIFICATION

A dolly is provided for moving, stacking and storing tubular space frame truss. Tubular truss is used in the entertainment industry for temporary stage systems and temporary rigging systems to hold lights, speakers, and other entertainment equipment. Truss systems can be very large and require a lot of labor to move truss in and out of trucks and around the entertainment venue. It would be beneficial to have a dolly which would allow the efficient stacking of truss in trucks and in warehouses. It would also be beneficial to have a dolly that allows the truss to be stacked while secured to a dolly, so that truss can be removed from the stack and immediately rolled to its destination.

Tubular space frame truss is made of various sized tubular elements. The longitudinal elements are called truss chords or chords. Truss chords can be of various diameters. The truss chords are connected by webbing elements. A truss is a single unit of truss chords along with the webbing that hold them together. Truss has two or more chord elements and can have any number of webbing elements sufficient to hold the truss together. The most common sizes are 12 in.×12 in., 16 in.×16 in., 20.5 in.×20.5 in., 24 in.×24 in., and 36 in. x 36 in. The dollies of the present invention can be made to attach to truss of various shapes, including the sizes above. However, the truss dollies of the present invention are not limited to holding standard size truss.

In one aspect, the invention is a doily comprising (a) an elongated v-shaped frame comprising a pair of upper edges, wherein said upper edges comprise a plurality of recesses: (b) a mechanism for securing truss to the dolly; and (c) a plurality of casters.

The frame can be made out of any material strong enough to support truss. For example, the frame can be made out of any material which has sufficient strength to hold a stack of truss, such as aluminum or steel. Preferably, the material is thick enough to support the truss, but is not so thick that the dolly cannot be picked up. In order to make the elongated v-shaped frame, a piece of flat sheet metal can be cut to the appropriate size and with the appropriate features, and then bent. Alternatively, the v-shaped frame can be made by extrusion.

A dolly comprising an elongated v-shaped frame has many benefits. The v-shape reduces the amount of material required for construction of the dolly, while at the same time allowing the dolly to have sufficient strength to hold hundreds or even thousands of pounds of truss. An elongated v-shaped frame is stiffer, although it has less mass, than an elongated u-shaped dolly. The v-shape also allows for the cutting of recesses in the central ridge of the frame so that the dolly can be stacked on top of truss. With the appropriate stiffeners or bases secured in the interior of the elongated v-shape, recesses into the central ridge can be cut with little or no loss in overall stiffness of the frame. Bases anchor stiffeners can be secured to the frame by any method known in the art, including welding and bolting.

In another aspect, the frame of the dolly is an elongated u-shape. An elongated u-shape also allows the presence of recesses in both the upper edges of the frame and in the bottom of the frame so that truss can be stacked on top of the doily and at the same time, the dolly can sit on top of a different stack of truss. The elongated u-shaped frame can also have appropriately shaped bases or stiffeners secured to the frame to increase stiffness. A u-shaped frame can be made by either extrusion or bending.

The length of the frame of the dolly depends upon the number of truss that are going to be stacked on the dolly. The frame should be long enough to hold the desired number of truss, but not so wide that the frame of the dolly extends beyond the truss. For example, a dolly designed to hold three pieces of truss each having a side that is 12 inches wide should be wide enough to hold all three pieces, but be less than 36 inches long. Therefore, the frame of the dolly does not hinder the placement of multiple stacks of truss immediately next to each other.

In another aspect, a dolly comprising either an elongated v-shaped frame or an elongated u-shaped frame has a pair of upper edges comprising a plurality of recesses. The purposes of the recesses is to locate the truss on the frame of the dolly. The shape and size of the recesses should allow the truss chord to fit snugly into them. Truss chords can be any diameter, but come in standard sizes of generally about 1.5 inches to about 2 inches in diameter. The recesses should be located on the frame so that the truss fits snugly on the frame. Various embodiments of the dollies of the present invention can be made to fit truss chords of different sizes.

In another aspect, a frame comprises a central ridge comprising a plurality of recesses. The recesses on the central ridge of an elongated v-shaped frame or on the bottom of an elongated u-shaped frame are used to locate, a dolly-truss pack on top of truss so that it can be stacked. Like the recesses of the upper edges, the size and location of the recesses of the central ridge (or bottom) can be placed in an appropriate location to accommodate truss of a particular size and/or shape.

The size and location of the recesses of both the upper edge and the central ridge or bottom) of the frame of the dolly can be altered to accommodate any shape and size truss. For example, a dolly designed to carry three pieces of truss each having a side that is 12 inches long, would have at least 6 recesses—4 in the upper edges and 2 corner recesses. The recesses in the corner allow the truss to hang over the side of the dolly.

For dollies having an elongated v-shaped frame, the recesses must be elliptical (when viewed in 2 dimensions) in order to hold a tubular truss chord. When viewed from the side in three dimensions, it can be seen that elliptical recesses create a round shape, and thus can accept a tubular truss chord.

The casters used in the dolly of the present invention can be any caster rated to hold sufficient weight to support multiple stacks of truss. Preferably, the casters are rated to hold at least 300 pounds. The casters can also be rated to hold more than 500 pounds, more than 1000 pounds, or more than 1500 pounds.

The type of casters in the present invention will be of a type known to a person of ordinary skill in the art. The casters can be any type, such as hollow-king pin or stem-type. They can be attached to the frame by any method known in the art, including bolting or welding. Dollies comprising, an elongated v-shaped frame minimize the overall height of the assembly so that the largest size wheel can be used. However, there is still sufficient distance between the bottom of the truss and the floor.

Additionally, dual casters may be used to reduce the amount of force needed to move, the dolly (so they can counter-rotate). Preferably, the caster is located far enough towards the center of the dolly that there is no position at which it extends beyond the frame of the dolly. This will prevent the caster from interfering with the placement of truss-dolly packs immediately next to each other in, for example, a truck.

In another aspect, each of said casters has a central pivot that is integrated into the frame. This will minimize the overall height of the dolly. The central pivot can be integrated into the frame by a number of bearings, such as a thrust bearing, a radial support bearing, and/or a retainer to keep the caster shaft from falling out. A machined housing, welded into the frame of the truss dolly has the locating features for the bearing elements machined into it.

In yet another aspect, the caster is mounted to a boss which is welded into the frame of the dolly providing the structural support necessary to eliminate the top plate on the caster and allow the use of a hollow-king pin or stem-type caster.

Preferably, neither the frame nor the casters of the dolly extends beyond the truss that is to be stacked on the dolly, allowing a truss-dolly pack to be rolled along a second truss-dolly pack without the dolly getting caught up in the truss. This allows for efficient movement into and out of trucks and warehouses and the efficient use of space in both trucks and warehouses.

In yet another aspect, the frame comprises at least one slot of a size sufficient to act as a handle.

In another aspect, the doily further comprises a slot that can be used to carry an empty truss dolly. The slot is preferentially big enough to fit a gloved hand. A slot can be located on just one side of the frame or on both sides of the frame. The slot is preferably at least 3 inches, at least 4 inches, at least 5 inches, or at least 6 inches long, his preferably also at least 2 inches, at least 3 inches, or at least 4 inches tall. It can be cut out of the frame by any method known in the art, including laser cutting or water-jet cutting. It can also be lined with or covered by a rubber gasket to make carrying the dolly more comfortable.

In another aspect, said upper edges or recesses of the frame are covered by a rubber gasket. A rubber gasket will protect the truss from damage if it hits the dolly. A rubber gasket is a slotted gasket that is applied by putting pressure onto the edge of the frame. It may be adhered with a sealant. The recesses in the central ridge of bottom of the frame of the dolly may also be lined with rubber gasket. Rubber gasket can be made of any type of rubber.

The dollies of the present invention may have multiple mechanisms to secure truss to the dolly.

In one aspect, the dolly has a pair of slotted receivers for accepting ends of a strap. Such receivers are well known in the art. For example, receivers can be a receiver for a J-hook type of strap attachment or an e-track type of attachment (quick disconnect). The strap can be used to secure truss to the dolly. Preferably, one slotted receiver is on each end of the dolly, allowing the strap to connect to one end, be placed over top of a stack of truss, and then secured to the second end of the dolly. The ratchet hinder can be used to tighten down the strap.

In another aspect, the dolly has a second pair of slotted receivers for accepting ends of strap. A second pair of slotted receivers can be used, for example, to secure a first truss-dolly pack to a second truss-dolly pack.

In yet another aspect, the invention is a doily comprising (a) a frame comprising a plurality of recesses; (b) a mechanism for securing truss to the dolly, wherein said mechanism comprises a moveable operating rod connected to a retaining finger, wherein said retaining finger has an engaged position at which said retaining finger can hold truss chord in the recesses of the frame; and (c) a plurality of casters.

In another aspect, the doll comprises a mechanism for securing truss to the dolly, wherein said mechanism comprises a moveable operating rod connected to a retaining finger, wherein said retaining finger has an engaged position at which said retaining finger can hold truss chord in the recesses of the frame. A dolly having two casters is of unstable and wants to fall over. By connecting the truss chord at a point midpoint in between the supporting surfaces of the dolly, and restraining it to those surfaces, it keeps the dolly fronm falling over and allows the rest of the truss to be stacked. This is useful mechanism for initially securing the truss chord to the dolly as it keeps the truss chord in intimate contact with the recess of the frame of the dolly. The mechanism can be, but does not have to be, spring actuated.

In yet another aspect, the operating rod is guided during operation by at least one base comprising a hole which axially guides the operating rod. The base is preferably made out of the same material as the frame of the dolly. It can be attached to the dolly by any method known in the art, including bolting and welding.

In another aspect, the operating rod has an end portion that is larger than a hole through which the operating rod is guided.

In yet another aspect, the invention is a dolly comprising (a) a frame comprising a plurality of recesses; (b) a retractable tensionable strap; and (c) a plurality of casters.

In another aspect of the invention, the dolly comprises a retractable tensionable strap. Retractable tensionable straps are known to a person of ordinary skill in the art. A retractable tensionable strap that is integrated with the dolly keeps the ratchet binder within the frame of the dolly, thus ensuring that there is nothing on the outside of the truss to interfere with efficient storing, stacking or moving of truss.

The ratchet hinder can be secured to the inside of the frame of the dolly by any method known in the art, including bolting and welding. The ratchet hinder may also be integrated into the frame of the dolly such that the frame of the dolly also acts as the binder frame.

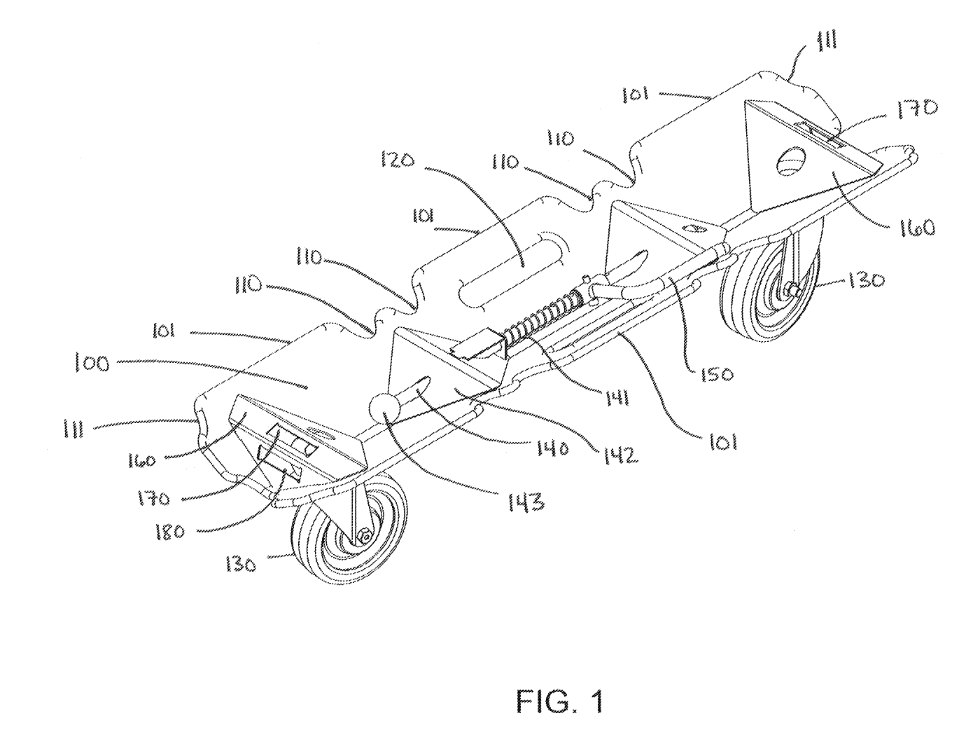

FIG. 1 is a perspective view of an embodiment of a dolly. In this figure, a frame 100 has v-shape. The frame has upper edges 101. The upper edges 101 base recesses 110 and corner recesses 111 in the frame of the dolly to allow the tubular chord tube to sit against the frame of the dolly. The dolly also has a slot 120 that can be used as a handle to carry the dolly. The dolly has casters 130 that allow the doll to roll along the floor.

The dolly shown in FIG. 1 has a operating rod 140 which is connected to a retaining finger 150. The mechanism can be, but does not have to be, spring-actuated. In the embodiment shown, the operating rod has a spring 141 attached to it and sits within a base 142. The operating rod end 143 can be pulled back, loading the spring 141. Upon turning the operating rod to raise the retaining finger 150, the operating rod end 143 can be released so that the retaining finger 150 snaps aver a truss chord.

The base 142 can also act as a stiffener to provide additional structural support to the frame 100 of the dolly. It can be connected to the frame 100 by any means known in the art, including welding and bolting.

The frame also has a stiffener 160 on each end. The stiffener 160 has a first slotted receiver 170 and a second slotted receiver 180. The first slotted receiver 170 on each end of the dolly can be used to strap the truss to the dolly. The second slotted receiver 180 can be used to strap a first truss-dolly package to a second truss-dolly package.

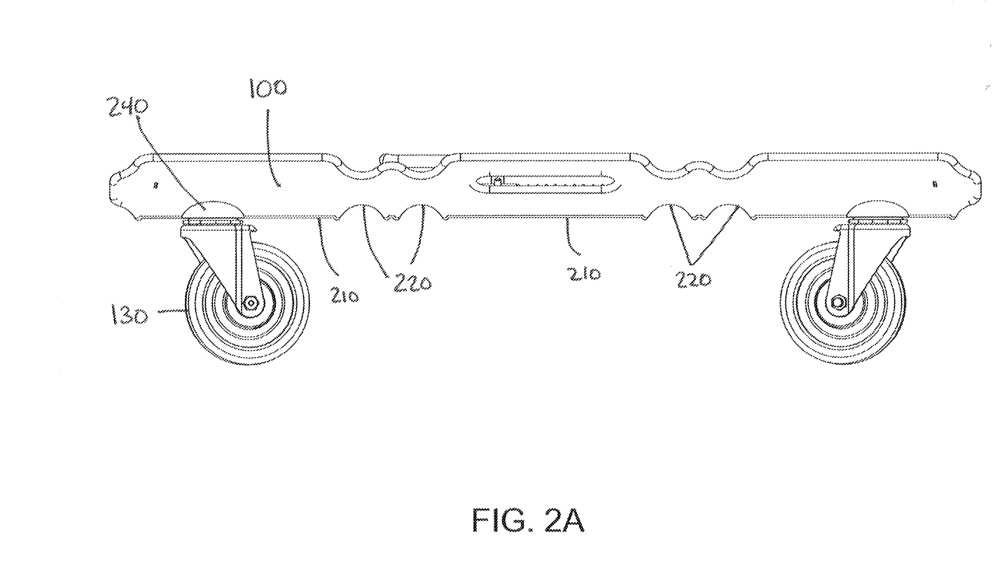

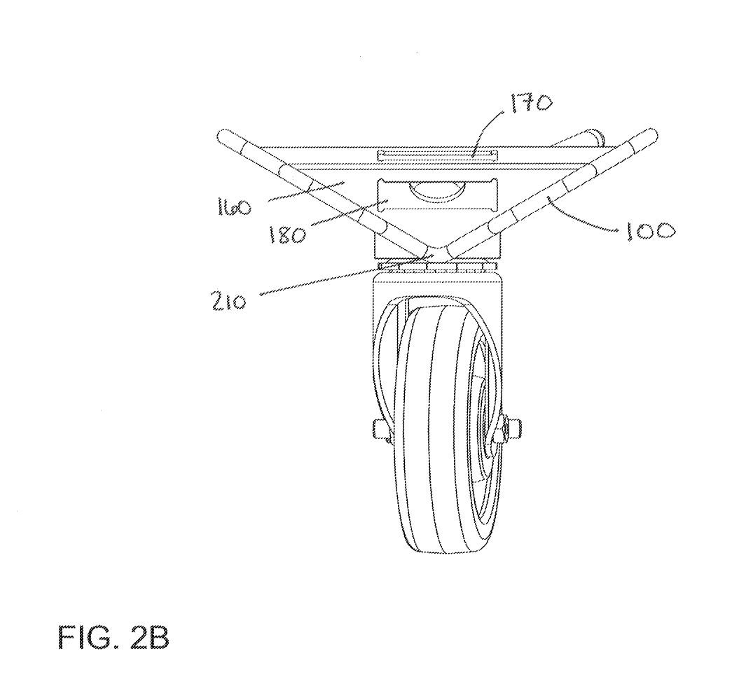

FIG. 2A is a side view of an embodiment of the truss dolly of the present invention. The frame 100 has a central ridge 210. The central ridge 210 has recesses 220 so that the dolly can be positively located on top of truss chord tubes. The caster 130 is connected to a boss 240 that is integrated with the frame 100. It can either be welded or bolted onto the frame.

FIG. 2B shows the end view of the dolly. Frame 100 has a central ridge 210. The frame also has a stiffener 160 comprising a first slotted receiver 170 and a second slotted receiver 180.

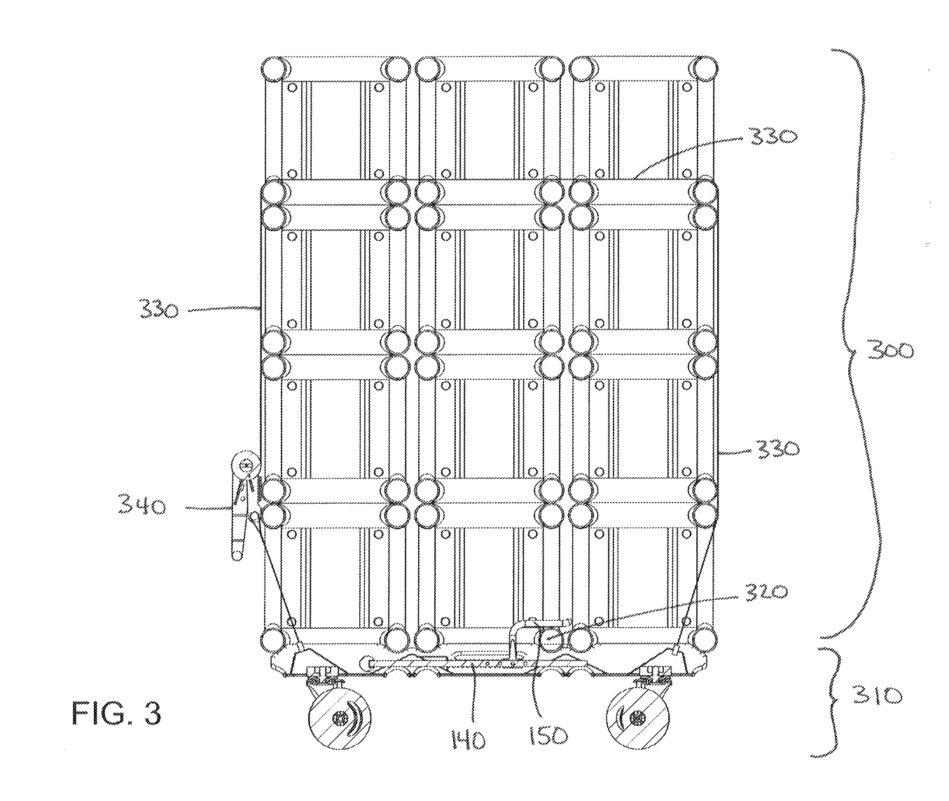

FIG. 3 illustrates a stack of 12 units of 12 inch×12 inch truss 300 secured on a sectioned view of a dolly 310. The dolly 310 is shown cut in half lengthwise so that the mechanism for securing truss to the dolly can be seen. The operating rod 140 is connected to the retaining finger 150. In this figure, it can be seen that the retaining finger 150 is in the locked position and in contact with truss chord 320. The stack of truss 300 is strapped to the dolly 310 with a strap 330 which is tightened around the truss with a ratchet 340.

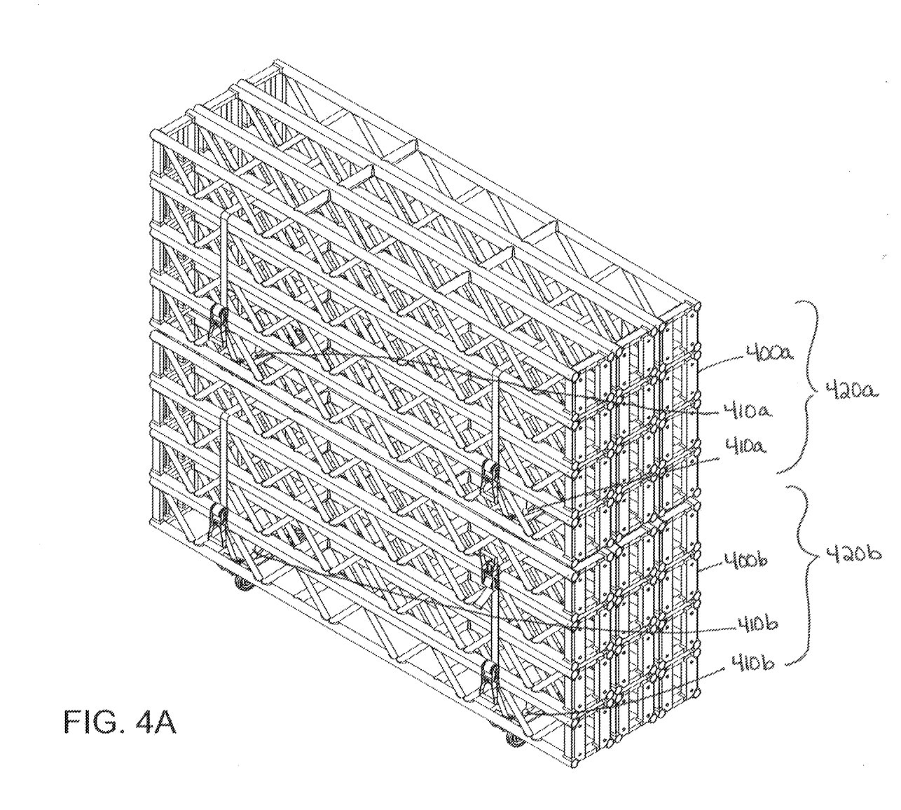

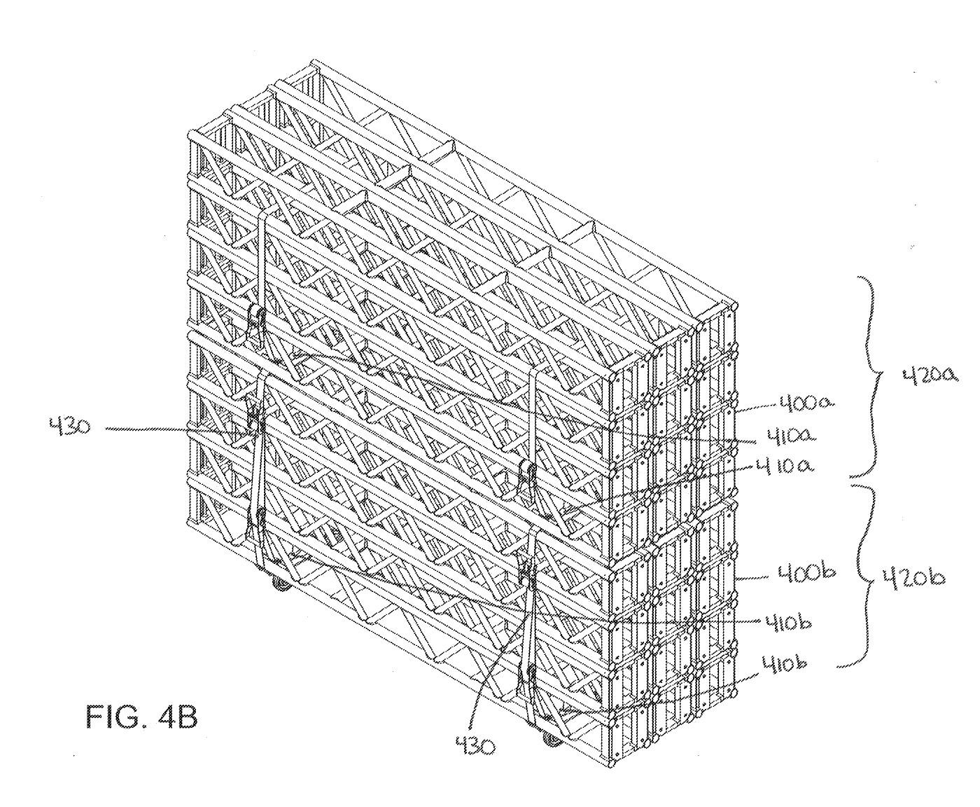

FIG. 4A illustrates the stacking ability of the doilies of the present invention. A first stack of truss 400a is mounted on a first pair of dollies 410a forming a first truss-dolly pack 420a. A second stack of truss 400b is mounted on a second pair of dollies 410b forming a second truss-dolly pack 420b. The first truss-dolly pack 410a is stacked on top of a second truss-dolly pack 420b.

FIG. 4B illustrates the elements shown in FIG. 4B and also illustrates a pair of straps 430 that secure the first truss-dolly 410a pack to the second truss-dolly pack 410b.

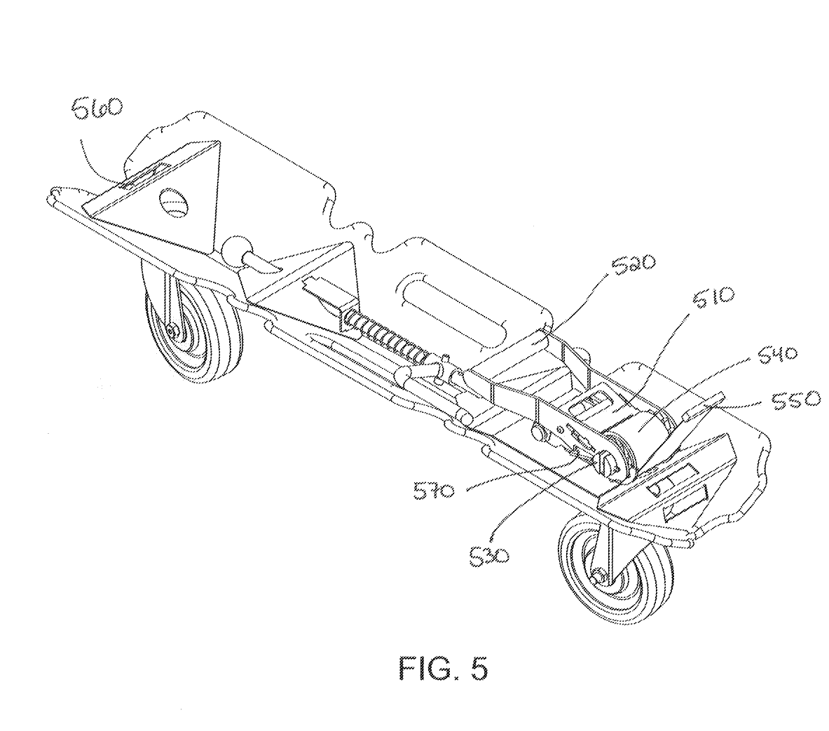

FIG. 5 shows another embodiment of the present invention. The dolly has a ratchet binder located within the frame of the dolly, said ratchet binder comprising a binder frame 510 attached to a lever 520. The binder frame 510 also has a take-up spool 530 around which the strap 540 is wrapped. The strap 540 has an end connection 550 which is able to attach to a slotted receiver 560. When the, the lock 570 is retracted and the lever 520 pushed fully against the hinder frame 510, the take up spool 530 will freely rotate, allowing the strap 540 to uncoil, providing enough length to reach around a package of truss and connect to the slotted receiver 560. The ratchet binder may be tightened by moving the leer 520 back and forth, thus securing the truss to the dolly.

Various embodiments having thus described in detail and by way of example, it will be apparent to those of skilled in the art that variations and modifications may be made and still achieve the desired outcome. The embodiments described herein include all such variations and modifications as fall within the scope of the claims.

1. A dolly comprising
(a) an elongated v-shaped frame comprising a pair of upper edges, wherein said upper edges comprise a plurality of recesses;
(b) a mechanism for securing truss to the dolly; and
(c) a plurality of casters.

2. A dolly as claimed in claim 1, wherein said frame comprises a central ridge comprising a plurality of recesses.

3. The dolly as claimed in claim 1, wherein said frame comprises at least one slot of a size sufficient to act as a handle.

4. The dolly as claimed in claim 1, wherein said upper edges of the frame are covered by a rubber gasket.

5. The dolly as claimed in claim 1, wherein each of said casters is mounted to a boss integrated into the frame of the dolly.

6. The dolly as claimed in claim 1, wherein said dolly has a pair of slotted receivers for accepting ends of a strap.

7. The dolly as claimed in claim 6, wherein said dolly has a second pair of slotted receivers for accepting ends of a strap.

8. The dolly as claimed in claim 1, wherein said mechanism for securing truss to the dolly comprises a moveable operating rod connected to a retaining finger, wherein said retaining finger has an engaged position at which said retaining finger can hold truss chord in said recesses.

9. A dolly as claimed in claim 8, wherein said operating rod is guided during operation by at least one base comprising a hole which axially guides the operating rod.

10. A dolly as claimed in claim 9, wherein the operating rod has an end portion that is larger than a hole through which the operating rod is guided.

11. A dolly comprising
(a) a frame comprising a plurality of recesses;
(b) a mechanism for securing truss to the dolly, wherein said mechanism comprises a moveable operating rod connected to a retaining finger, wherein said retaining finger has an engaged position at which said retaining finger can hold truss chord in the recesses of the frame; and
(c) a plurality of casters.

12. A dolly as claimed in claim 11, wherein said operating rod is guided during operation by at least one base comprising a hole which axially guides the operating rod.

13. A dolly as claimed in claim 12, wherein the operating rod has an end portion that is larger than a hole through which the operating rod is guided.

14. The dolly as claimed in claim 11, wherein the said frame comprises at least one slot of a sufficient size to act as a handle.

15. The dolly as claimed in claim 11, wherein each of said casters is mounted to a boss integrated into the frame of the dolly.

16. The dolly as claimed in claim 11, wherein said dolly has a pair of slated receivers for accepting ends of a strap.

17. The dolly as claimed in claim 16, wherein said dolly has a second pair of slotted receivers for accepting ends of a strap.

18. The dolly as claimed in claim 11, wherein the frame of the dolly is either an elongated v-shape or an elongated u-shape.

19. A dolly comprising
(a) a frame comprising a plurality of recesses;
(b) a retractable tensionable strap; and
(c) a plurality of casters.

20. The dolly as claimed in claim 19, wherein said frame comprises at least one slot of a size sufficient to act as a handle.

21. The dolly as claimed in claim 19, wherein each of said casters is mounted to a boss integrated into the frame of the dolly.

22. The dolly as claimed in claim 19, wherein the dolly has a mechanism for securing truss to the dolly, wherein said mechanism comprises a moveable operating rod connected to a retaining finger, wherein said retaining finger has an engaged position at which said retaining finger can hold truss chord in said recesses.

23. A dolly as claimed in claim 22, wherein said operating rod is guided during operation by at least one base comprising a hole which axially guides the operating rod.

24. A dolly as claimed in claim 23, wherein the operating rod has an end portion that is larger than a hole through which the operating rod is guided.

25. A dolly as claimed in claim 19, wherein said frame is an elongated v-shape or an elongated u-shape.

26. The dolly as claimed in claim 25, wherein said frame comprises a central ridge comprising a plurality of recesses.

27. The dolly as claimed in claim 19, wherein said dolly comprises a pair of slotted receivers for accepting ends of a strap.

28. The dolly as claimed in claim 27, wherein said dolly has a second pair of slotted receivers for accepting ends of a strap.

29. A dolly comprising
(a) an elongated v-shaped frame comprising a pair of upper edges and a central ridge;
(b) a mechanism for securing truss to the dolly; and
(c) a plurality of casters.
